(19) United States
(12) Patent Application Publication
(10) Pub. No.: US 2002/0087428 A1
(43) Pub. Date: Jul. 4, 2002

(54) Fixed-monetary-amount purchasing system for precious metals

(75) Inventors: Tetsurou Koide, Yachiyo (JP); Masaru Sumiyoshi, Tokyo (JP); Toshiyuki Kunii, Tokyo (JP)

Correspondence Address: KODA & ANDROLIA, Suite 3850, 2029 Century Park East, Los Angeles, CA, 90067-3024, US

(73) Assignee: TANAKA KIKINZOKU KOGYO KABUSHIKI KAISHA

(21) Appl. No.: 09/865,647

(22) Filed: May 25, 2001

Related U.S. Application Data
(60) Provisional application No. 60/258,825, filed on Dec. 28, 2000.

(51) Int. Cl. G06F 17/60

(52) U.S. Cl. 705/26; 705/39

(57) ABSTRACT

The object of the present invention is to provide an efficient and safe investment system in purchasing precious metals at a fixed-monetary-amount on a continuous basis. This system allows to quickly execute the process for sales, returns, same-day spot purchases, and equal-value exchanges at low cost in connection with precious metals such as gold and platinum, etc. In the fixed-monetary-amount purchasing system of this invention, client servers of clients are connected to a main server of a purchasing organization via internet. The clients connect to a fixed-monetary-amount exclusive use site from their client servers, and apply for subscription-registration, balance inquiries, same-day spot purchases, returns, sales, equal-value exchanges and investment, etc., and the purchasing organization executes the specified services while referring to data in a client data base, a financial institution server and a market price file.

### BACKGROUND OF THE INVENTION

1. Field of the Invention

The present invention relates to a system for periodically purchasing precious metals by the so-called dollar cost averaging method.

2. Prior Art

There has been known an investment system on precious metals designed for general consumers through which precious metals such as gold or platinum are periodically purchased.

In practice, two methods have been commonly used. One is a “simple average purchasing method” in which a fixed amount is continually purchased, and the other is a “dollar cost averaging method” in which purchases are continued at a fixed monetary amount. Both methods were developed in order to reduce the risk caused by the fluctuation in precious metal prices.

In comparing the above two methods, the dollar cost averaging method always results in a lower average purchase price than the simple average purchasing method. Accordingly, the dollar cost averaging method has been more commonly used. The weight of metals purchased as an investment can be determined in accordance with the client's budget.

In practicing this method, clients establish respective accounts with a purchasing organization, and the merchandise consisting of precious metals such as gold or platinum, etc., that is purchased is placed in protective custody in these accounts; furthermore, merchandise held in protective custody may be returned, such merchandise may be exchanged for other merchandise of equal value, or the sale of merchandise held in protective custody to the purchasing organization may be requested, and the payment of the sale price may be received.

Furthermore, funds corresponding to the purchase price of merchandise may be appropriately transferred from financial-institution accounts used for settlement by the clients to the financial-institution account of the purchasing organization, or funds may be transferred in the opposite direction.

In such a fixed-monetary-amount purchasing system for precious metals, the industry has not experienced any serious problems in carrying out the normal procedure of periodically purchasing merchandise consisting of predetermined monetary amount of metals. However, procedures, inquiries and confirmation work are getting more complex in cases such as, (a) where the monetary amount of the purchase is altered, (b) where merchandise is spot-purchased on a given day, (c) where merchandise held in protective custody is returned, (d) where merchandise held in protective custody is sold, and the sale price is paid into the financial-institution account of the client, (e) where merchandise held in protective custody is exchanged for other merchandise of equal value, and (f) where the purchasing organization invests merchandise held in protective custody for the profit of the client, etc.

To accommodate the complexity of the procedures involved, the industry has been seeking a more organized and sophisticated system to maximize the benefits of the fixed monetary amount purchasing system for precious metals.

### SUMMARY OF THE INVENTION

The present invention was devised to resolve the abovementioned problems in the prior art. Accordingly, the general object of the present invention is to provide a fixed-monetary-amount purchasing system for precious metals in which clients can enjoy a wide variety of services in a quicker and safer fashion in addition to the conventional fixed-monetary-amount purchasing services.

It is another object of the present invention to provide a fixed-monetary-amount purchasing system for precious metals which allows the customers a more efficient and reliable access to any part of the operation of the system so that the customers may be able to make a more informed and timely decision.

In keeping with the principles of the present invention, the objects are accomplished by the fixed-monetary-amount purchasing system, in which client servers of clients are connected to a main server of a purchasing organization via internet. The clients connect to a fixed-monetary-amount exclusive use site from their client servers, and apply for subscription-registration, balance inquiries, same-day spot purchases, returns, sales, equal-value exchanges and investment, etc., and the purchasing organization executes the specified services while referring to data in a client data base, a financial institution server and a market price file.

### BRIEF DESCRIPTION OF THE DRAWINGS

FIG. 1 is a block diagram which shows an overall outline of a fixed-monetary-amount purchasing system for precious metals of the present invention.

FIG. 2 is a block diagram which shows the electronic sites and selection menu in the fixed-monetary-amount purchasing system.

FIG. 3 is a flow chart which illustrates the main fixed-monetary-amount purchasing procedure utilizing the internet in the fixed-monetary-amount purchasing system.

FIG. 4 is a flow chart which illustrates the subscription-registration procedure utilizing the internet in the fixed-monetary-amount purchasing system.

FIG. 5 is a flow chart which illustrates the same-day spot purchasing procedure utilizing the internet in the fixed-monetary-amount purchasing system.

FIG. 6 is a flow chart which illustrates the merchandise return procedure utilizing the internet in the fixed-monetary-amount purchasing system.

FIG. 7 is a flow chart which illustrates the sale price payment procedure utilizing the internet in the fixed-monetary-amount purchasing system.

FIG. 8 is a flow chart which illustrates the merchandise equal-value exchange procedure utilizing the internet in the fixed-monetary-amount purchasing system.

FIG. 9 is a flow chart which illustrates the merchandise investment service procedure utilizing the internet in the fixed-monetary-amount purchasing system.

### DETAILED DESCRIPTION OF THE INVENTION

In general, the present invention achieves the abovementioned object by means of a fixed-monetary-amount purchasing system for precious metals comprises the steps of:

(a) registering for each of client accounts in a client data base, (i) information concerning clients who have concluded fixed-monetary-amount purchasing agreements with a purchasing organization for the continued purchase of merchandise comprising precious metals at a fixed purchase price at fixed intervals, (ii) information concerning said merchandise that has been purchased by said clients and that has been placed in protective custody in a client account established with said purchasing organization, (iii) information concerning money deposited by clients in said client accounts, (iv) information concerning accounts at financial institutions used for settlement by said clients, and (v) information concerning said fixed prices of said fixed-monetary-amount purchases that have been requested by said clients,

(b) recording in said client data base via a main server of said purchasing organization at the time of fixed-monetary-amount purchases, (i) the presence or absence of a payment into the financial-institution account of said purchasing organization, and (ii) means of payment, either a transfer of funds corresponding to said purchase price from said financial-institution accounts of said clients or a cash payment

(c) purchasing merchandise on each business day with an amount of money determined by dividing said purchase price by the number of business days within a fixed period when recording of said payment in said client data base is confirmed,

(d) storing said purchased merchandise in protective custody for said client accounts in each instance, and

(e) settling at a request of said clients for said merchandise stored in said protective custody by providing actual merchandise, exchanging said merchandise for other merchandise of equal value, or paying funds resulting from sale of said merchandise.

In the aforementioned fixed-monetary-amount purchasing system for precious metals, the system may be devised so that (a) when a person desiring a fixed-monetary-amount purchasing agreement sends a request for such an agreement to the main server of the aforementioned purchasing organization via a communications circuit, the aforementioned main server tentatively registers the client information obtained from the aforementioned request in the aforementioned client data base, and (b) when the financial-institution account used for settlement by the aforementioned requestor has been established, the aforementioned tentative registration in the aforementioned client data base is updated to a full registration, the aforementioned client account is set in the client data base, and the aforementioned requestor is informed of the acceptance of the aforementioned full registration.

Furthermore, in the aforementioned fixed-monetary-amount purchasing system for precious metals, the system may be devised so that when one of the aforementioned clients sends a request for a spot purchase of merchandise including purchase price data to the aforementioned main server by means of a client server via a communications circuit, (a) the aforementioned main server determines the purchase weight from the aforementioned purchase price by referring to a market price file, and confirms either that the aforementioned purchase price has been paid from the financial-institution account of the aforementioned client, or that the aforementioned purchase price remains in the aforementioned client account at the purchasing organization as a deposit, and (b) following this confirmation, the purchase of merchandise of the aforementioned purchase weight is executed, and the purchased merchandise is placed in protective custody in the aforementioned client account.

The system may be devised so that the confirmation of payments into the financial-institution account of the aforementioned purchasing organization is accomplished by the aforementioned main server using net banking.

The system may be devised so that a purchase confirmation notification is sent to the aforementioned client data base and client server via a communications circuit following the execution of the purchase of the aforementioned merchandise.

The system may be devised so that when a client who desires to return merchandise held in protective custody sends a request for a balance inquiry regarding merchandise held in protective custody to the aforementioned main server from his client server via a communications circuit, (a) the aforementioned main server refers to the aforementioned client data base and supplies information concerning the merchandise held in protective custody to the aforementioned client server, (b) the main server also invites an application from the client server to the aforementioned main server for the return of merchandise within the limits of the aforementioned merchandise held in protective custody, and (c) the aforementioned main server transmits a confirmation of the return to the client server, rewrites the information concerning the merchandise held in protective custody in the aforementioned client data base, and arranges the execution of the return of the merchandise.

The system may be devised so that in cases where there has been a request for the return of merchandise as described above, (a) the aforementioned main server refers to the aforementioned client data base and judges whether or not the balance of the merchandise held in protective custody following such a return will exceed the minimum amount held in custody, and (b) if the results of this judgment are positive, the main server executes a return procedure.

The system may be devised so that in cases where the aforementioned judgment results obtained by the aforementioned main server are negative, the main server selects the option of (a) transmitting information to the client server that invites a re-application for return within limits that leaves the aforementioned minimum amount held in protective custody, or (b) performing an automatic return registration, and executing the return procedure in cases where the amount held in protective custody reaches the sum of the aforementioned minimum amount held in protective custody and the amount for which return is requested.

The system may be devised so that when a client who desires to sell merchandise held in protective custody sends a request for a balance inquiry regarding merchandise held in protective custody to the aforementioned main server from his client server via a communications circuit, (a) the aforementioned main server refers to the aforementioned client data base and supplies information concerning the merchandise held in protective custody to the aforementioned client server, (b) the main server also invites an application from the client server to the main server for the sale of merchandise within the limits of the aforementioned merchandise held in protective custody, and (c) after executing the sale, the aforementioned main server transmits a confirmation of sale to the client server, rewrites the information concerning the merchandise held in protective custody in the aforementioned client data base, and either deposits the sale price in the client account or pays the sale price to the financial-institution account of the client.

The system may be devised so that when the aforementioned client requests the sale of merchandise, (a) the aforementioned main server supplies information inviting a designation of the desired sale price to the client server, (b) in cases where there is a specification of the desired sale price by the client, the main server refers to a market price file which has current market price data for merchandise within a fixed period of time, and executes a purchase from the client at the aforementioned specified price if this specified prices appears in the market price file, and (c) in cases where the aforementioned specified price does not appear in the market price file, the main server notifies the client of this and cancels the acceptance of the sale request.

The system may be devised so that (a) the aforementioned main server can be connected via an electronic commercial transaction site to an electronic commercial transaction file in which various types of information concerning electronic commercial transactions are registered, (b) when a client who desires an equal-value exchange of merchandise held in protective custody is connected to the aforementioned electronic commercial transaction site of the aforementioned main server from the client server via a communications circuit, the main server sends information inviting (i) the selection of the desired merchandise from the aforementioned electronic commercial transaction file, and (ii) an application for equal-value exchange, to the client server, and (c) when the client selects the merchandise and applies for an equal-value exchange, the main server refers to the aforementioned client data base, and if the value of the merchandise held in protective custody exceeds the value of the selected merchandise, the main server subtracts an amount of merchandise held in protective custody that is equal in value to the selected merchandise, rewrites the client data base, and sends instructions to the aforementioned electronic commercial transaction file for the purchase of the aforementioned selected merchandise and the shipping of said merchandise to the aforementioned client.

The system may be devised so that when information inviting an application for the investment of merchandise held in protective custody has been sent along with investment rate information to the client server of the aforementioned client by the aforementioned main server, and there has been an application for investment from the client specifying a weight of merchandise to be invested that is within the weight range of the merchandise held in protective custody, the main server judges whether or not the weight of the aforementioned merchandise is within the standard weight range for investment, and if the results of this judgment are positive, the main server transfers merchandise of the aforementioned weight from protective custody and executes the investment.

The system may be devised so that data concerning the performance of the aforementioned investment is accumulated in an investment file to which the client server of the client for whom the investment is registered can be connected, and the aforementioned client can refer to this investment file at any time.

The system may be devised so that (a) a marketplace information including the market price of the merchandise that is the object of investment is successively accumulated in the aforementioned investment file, (b) the aforementioned investment rate is periodically updated with reference to this marketplace information, (c) the updated investment rate is submitted to the client via the aforementioned investment file, and (d) in cases where the client is invited to submit an application indicating whether or not the investment at the updated investment rate is to be canceled, and if there is an application from the client to cancel the investment, the registration of the investment is canceled and the merchandise is transferred to merchandise held in protective custody for the client.

The system may be devised so that if there is no application for cancellation of the aforementioned investment, the loan charge for the invested merchandise is saved as a fund for spot purchases for the client.

The system may be devised so that the aforementioned main server sends at least one type of menu information concerning (a) balance inquiry requests for merchandise held in protective custody for the clients, (b) transaction history inquiry requests, (c) spot purchase applications, (d) applications for duplicate subscriptions, (e) introduction of new clients, (f) applications for the return of merchandise held in protective custody, (g) applications for the equal-value exchange of merchandise held in protective custody for other merchandise, or (h) applications for an investment service for merchandise held in protective custody, to the clients via a communications circuit, invites the clients to select desired information, and receives the selection made by the clients.

The system may be devised so that when a balance inquiry request if selected from the aforementioned menu information, an image of the merchandise held in protective custody is displayed by the client server in accordance with the type and weight of the merchandise.

Now, referring more particularly to the preferred embodiments of this invention, examples of a working configuration of the present invention will be described in detail with reference to the attached figures.

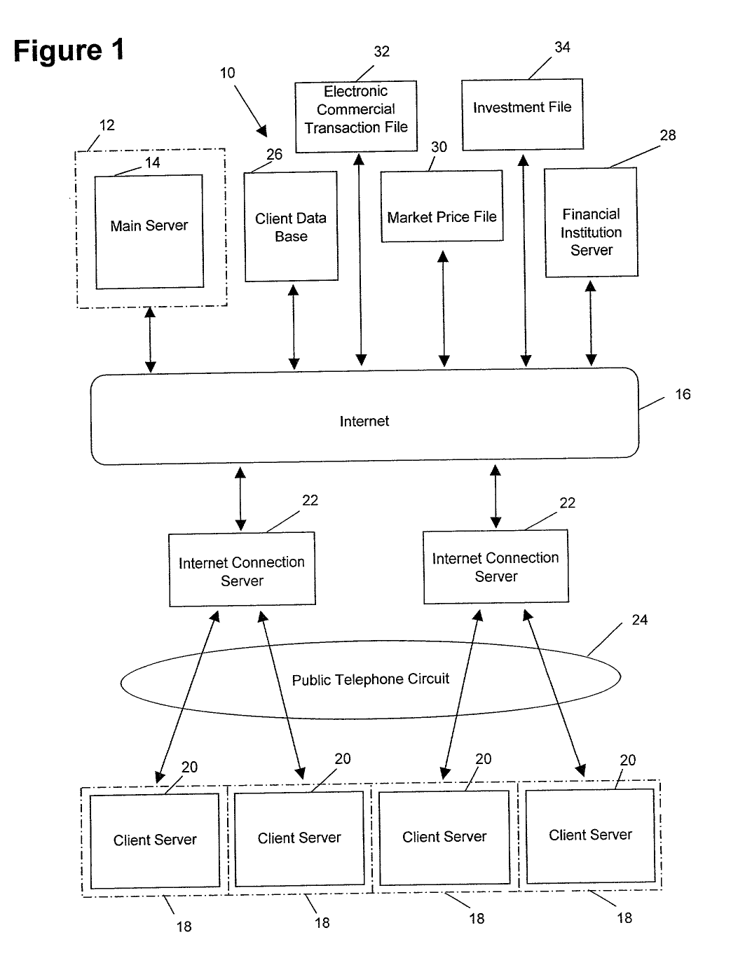

FIG. 1 shows an overall outline of a fixed-monetary-amount purchasing and settlement system for metals which constitutes one example of a working configuration of the present invention.

This fixed-monetary-amount purchasing system 10 is constructed so that it includes a main server 14 which is installed at the purchasing organization 12 for the purpose of purchasing precious metals such as gold and platinum, etc., and client servers 20 on the side of the clients 18, which are connected to the abovementioned main server 14 by means of the internet 16.

In the aforementioned internet 16, the aforementioned main server 14 and client servers 20 can be connected via internet connection servers 22 and a public telephone circuit 24.

Furthermore, a client data base 26 in which information concerning merchandise of the clients that is held in protective custody in client accounts established at the aforementioned purchasing organization 12, information concerning money deposited by the clients in these client accounts, information concerning financial-institution accounts used for settlement by the clients and information concerning the fixed monetary amounts of fixed-monetary-amount purchases that have been requested by the clients is registered for each client account, a financial institution server 28 which is used to input information concerning payments from the clients to the financial-institution account of the purchasing organization 12 into the main server 14 on-line by means of so-called net banking, a market price file 30 which contains market price data indicating successive variations in the prices of precious metals such as gold and platinum, etc., an electronic transaction file 32 in which numerous firms participate, and which contains data concerning merchandise offered by these participating firms, and an investment file 34 which contains data related to investments in cases where gold and platinum, etc., are invested by being utilized by leasing for industries such as mining, jewelry processing, or industrial manufacturing, etc., are respectively connected to the aforementioned internet 16, and can be connected to the main server 14 via the internet 16.

Furthermore, the aforementioned market price file 30, electronic transaction file 32 and investment file 34 may all alternatively be installed on the side of the main server 14.

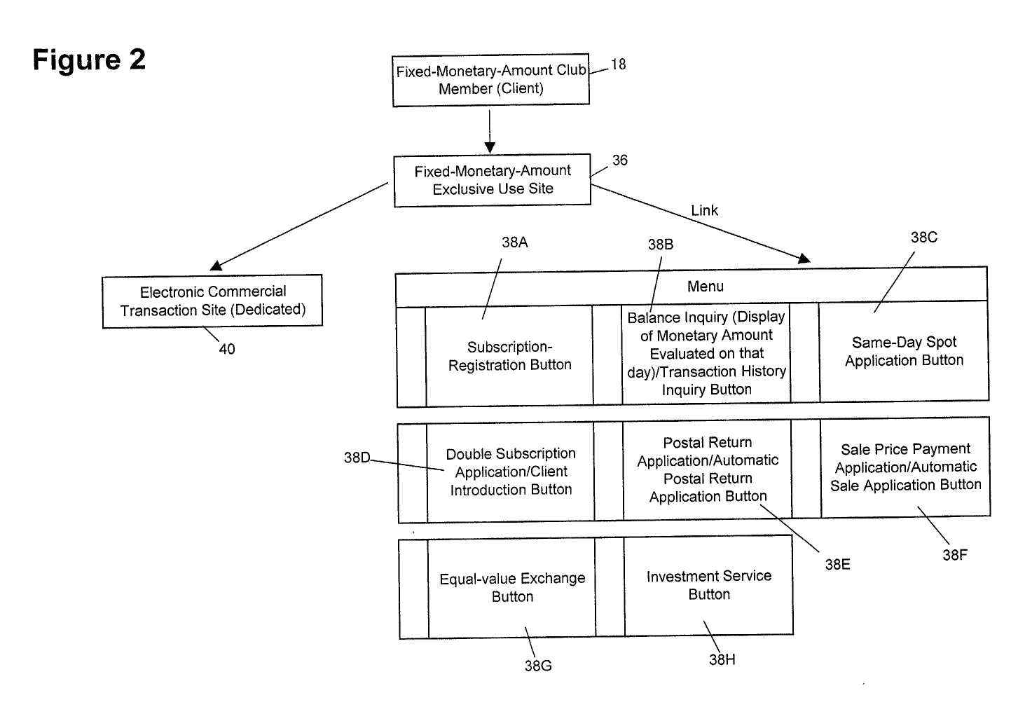

As is shown in FIG. 2, the aforementioned main server 14 is arranged as follows: specifically, a fixed-monetary-amount exclusive use site 36 is installed on the internet, and when clients who are fixed-monetary-amount club members or clients who desire a fixed-monetary-amount club member agreement connect with the aforementioned fixed-monetary-amount exclusive use site 36 by means of their client servers 20, the main server sends a menu that invites the selection of a procedure to these clients.

As is shown in FIG. 2, this menu consists of a screen which displays a subscription-registration button 38A, a balance inquiry (display of monetary amount evaluated on that day)/transaction history inquiry button 38B, a same-day spot application button 38C, a double subscription application/client introduction button 38D, a postal return application/automatic postal return application button 38E, a sale price payment application/automatic sale application button 38F, an equal-value exchange button 38G, and an investment service button 38H.

Furthermore, the system is arranged so that a connect on can be made from the aforementioned fixed-monetary-amount exclusive use site 36 to an electronic transaction site 40 which is connected to the aforementioned electronic transaction file 32.

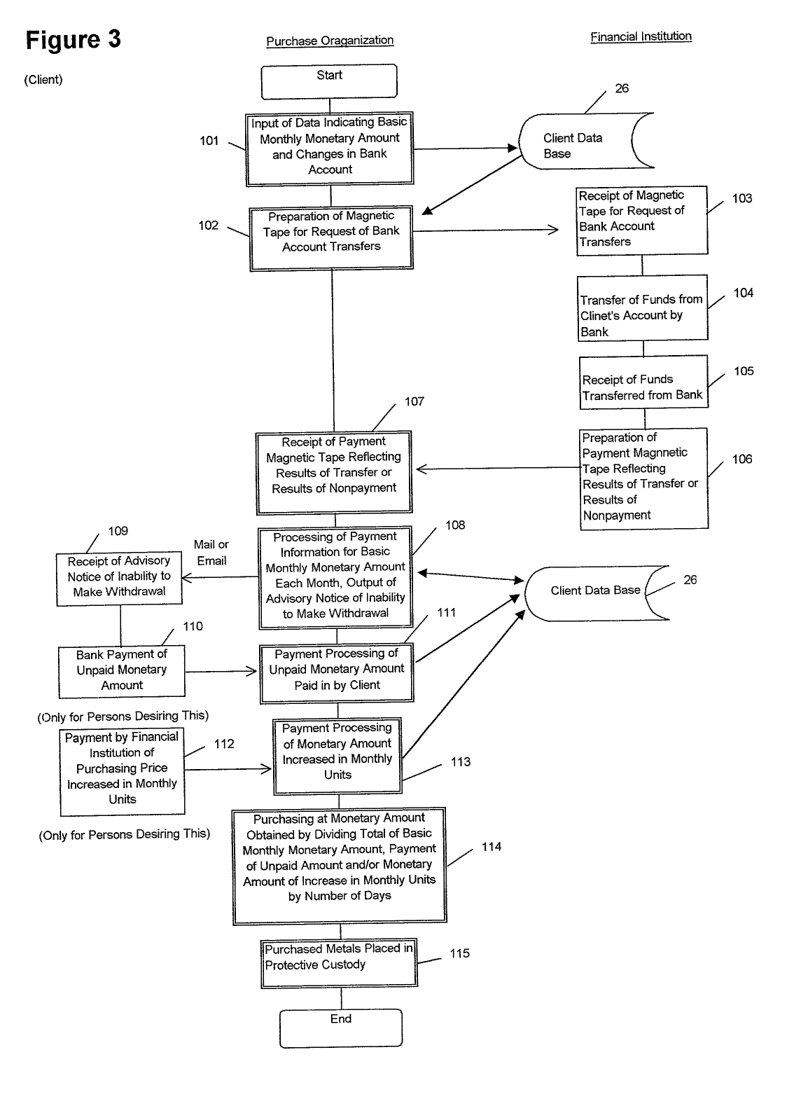

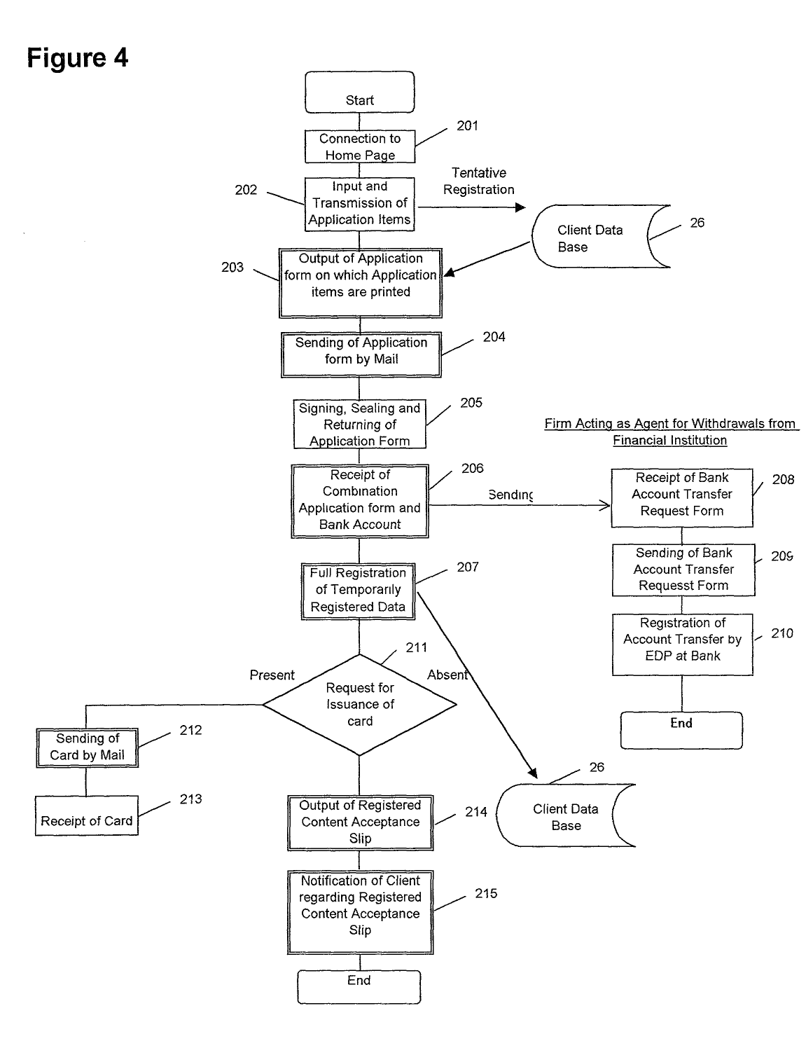

Next, the process by which a fixed-monetary-amount purchase of precious metals is executed will be described with reference to FIG. 3. In FIG. 3, and in FIGS. 4 through 9 as well, the steps shown in double-line boxes are performed by the purchasing organization 12.

At the purchasing organization 12, in step 101, basic monthly monetary amount data and necessary bank account update data for each month is input from the main server 14, and this data is registered in the client data base 26.

In step 102, a request magnetic tape for bank account transfers is prepared, and in step 103, this tape is sent through a settling agent to the client's financial institution, which has been reported beforehand by the client 18.

In step 104, the client's financial institution transfers the basic monthly monetary amount and necessary fee for each month from the client's account to the financial-institution account of the purchasing organization 12, and in step 105, the purchasing organization 12 confirms from the financial institution server 28 utilizing, for example, a net banking system that the transfer funds have been paid from the client's bank account through a settling agent.

Next, in step 106, a payment magnetic tape reflecting the aforementioned transfer results or nonpayment results is prepared at a settling agent, and this is sent to the purchasing organization 12.

In step 107, the purchasing organization 12 receives the aforementioned payment magnetic tape reflecting transfer results or nonpayment results, and proceeds to step 108.

In step 108, payment information concerning the basic monthly monetary amount, etc. for each month is processed on the basis of the aforementioned payment magnetic tape that has been received. In cases of nonpayment, i.e., in cases where the withdrawal of funds is impossible, an advisory notice that the withdrawal of funds is impossible is output to the client 18 by post or by e-mail via the internet 16, etc. Furthermore, information concerning payment is output to the client data base 26, and this information is registered. In the next step 109, the client 18 receives the advisory notice that the withdrawal of funds is impossible, and if the client wishes, the client pays an amount equal to the aforementioned nonpayment into the financial-institution account of the purchasing organization 12 in step 110.

In step 111, if there has been a payment of the aforementioned unpaid monetary amount from the client, this payment is subjected to payment processing, and is registered in the client data base 26. Furthermore, any client who wishes to increase the basic monthly monetary amount may pay purchase funds equal to the amount of increase from the client's financial institution into the financial-institution account of the purchasing organization 12 in step 112.

In step 113, if there has been such a payment of an increase in the basic monthly monetary amount, the purchasing organization 12 subjects this payment-to-payment processing, and registers this payment in the client data base 26.

In step 114, the purchase of the desired precious metals is executed on a daily basis using a monetary amount determined by dividing the total of the basic monthly monetary amount and the payment of the unpaid monetary amount or increase in the basic monthly monetary amount by the number of business days in the period, for example, one month. In step 115, the aforementioned purchased precious metals are successively subjected to protective custody processing, and purchasing is thus completed.

Next, the subscription and registration procedure for a client who wishes to subscribe and be registered in this fixed-monetary-amount purchasing system will be described with reference to FIG. 4.

First, in step 201, the client connects to the home page of the purchasing organization 12 from the client server 20 via the internet 16, and calls up the menu screen shown in FIG. 2 from the aforementioned fixed-monetary-amount exclusive use site 36.

Next, the client selects the subscription-registration button 38A from the aforementioned menu screen. When the subscription-registration button 38A is selected, the main server 14 sends information inviting the input of the client's address and other necessary data. Then, in step 202, the client 18 inputs this data in the application items, and this data is transmitted to the main server 14.

After receiving the subscription-registration application from the client, the main server 14 tentatively registers this application in the client data base 26; the main server 14 then proceeds to step 203, and outputs an application form on which the application items are printed, while referring to the items tentatively registered in the client data base 26. Then, in step 204, the application form is sent to the client 18 by mail.

In step 205, the client 18 signs and affixes his seal to the received application form, and returns this form to the purchasing organization 12.

The application form also serves as a financial-institution account transfer request form, and in step 206, the purchasing organization 12, which has received this application form, sends the account transfer request form to the firm acting as an agent for withdrawals from financial institutions. At the same time, the processing proceeds to step 207, where the tentatively registered data is altered to a full registration, and this is registered in the client data base 26.

In step 208, the account transfer request form sent form the purchasing organization 12 is received by the firm acting as an agent for withdrawals from financial institutions, and in step 209, this firm acting as an agent for withdrawals from financial institutions sends the account transfer request form to respective financial institutions; then, in step 210, the financial institutions that have received this form make an account transfer registration by means of EDP.

After full registration is accomplished in the previous step 207, the processing proceeds to step 211, and a judgment is made in the main server 14 as to whether or not a desire for card issuance is indicated on the aforementioned application form. If there is such an indication, a card is sent by mail to the client in step 212, and the client 18 receives this card in step 213.

Regardless of the results of the judgment made in step 211 regarding the presence or absence of a desire for card issuance, the processing proceeds to step 214, and a registration content receipt slip is output. Then, in the next step 215, the client is notified of this output registration content receipt slip by e-mail, and the procedure is completed.

In the subscription-registration procedure performed in the abovementioned steps 201 through 215, security is guaranteed by utilizing encryption techniques during data transmission (same below).

In this subscription-registration procedure, the application items are input by the person who desires a subscription himself, and are transmitted to the main server 14 of the purchasing organization 12; accordingly, separate application data input operations are unnecessary on the side of the purchasing organization 12. Consequently, input mistakes can be prevented, and the time required for subscription-registration can be shortened.

Furthermore, if electronic signatures are recognized, the procedure involved in the aforementioned steps 204 through 206 and 208 through 210 can be handled electronically, so that the time required for the subscription-registration procedure can be further shortened.

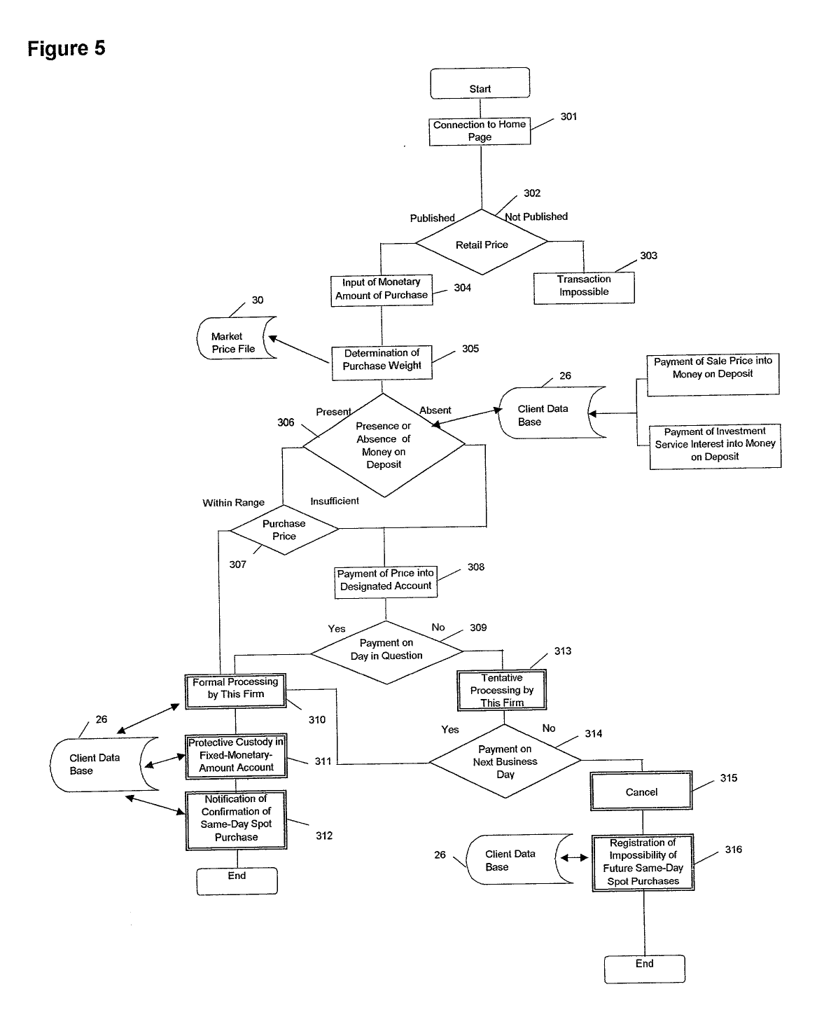

Next, the procedure by which merchandise consisting of precious metals is spot purchased on a given day by means of the aforementioned fixed-monetary-amount purchasing system 10 will be described with reference to FIG. 5.

First, in step 301, the client 18 connects to the aforementioned home page from the client server 20 via the internet 16. Furthermore, the client 18 enters the aforementioned fixed-monetary-amount exclusive use site 36, and after receiving the menu screen shown in FIG. 2 from the main server 14, the client 18 selects the same-day spot application button 38C from the aforementioned menu screen.

In step 302, a judgment is made from the market price of the desired merchandise at that point in time as to whether or not the retail price has been published. If there has been no such publication of the retail price, the processing proceeds to step 303, and a transaction is impossible. If the retail price has been published, the processing proceeds to step 304, and the client inputs the monetary amount of the purchase from the client server 20.

As a result, the main server 14 refers to the market price file 30, and determines the weight of the purchase from the aforementioned published retail price and the monetary amount of the purchase that has been input (step 305). Next, the processing proceeds to step 306, and the presence or absence of money on deposit equal to the monetary amount of the purchase is determined with reference to the client data base 26.

If there is no money on deposit, information inviting the payment of [the necessary] funds into a designated account of the purchasing organization 12 is sent to the client server 20. On the other hand, if there is money on deposit, the processing proceeds to step 307, and a judgment is made as to whether or not this money on deposit is sufficient for the aforementioned purchase price. If the money on deposit is insufficient, information inviting the payment of the insufficient amount into a designated financial-institution account of the purchasing organization 12 is output to the client server 20 in the same manner as described above (step 308).

Next, the processing proceeds to step 309, and a judgment is made as to whether or not a payment of the purchase price has been made into the aforementioned designated financial-institution account. In cases where a payment of the purchase price has been made or the purchase price is within the range of money on deposit in step 307, the processing proceeds to step 310, and formal processing, i.e., a same-day spot purchase, is executed by the main server 14. This is simultaneously registered in the client data base 26.

Next, the processing proceeds to step 311, and the spot-purchased merchandise is placed in protective custody in the client account. Then, in step 312, notification of the confirmation of a same-day spot purchase is transmitted to the client 18 by e-mail, and the procedure is completed. Furthermore, information concerning this protective custody and notification of confirmation is registered in the client data base 26.

In cases where there was no payment of the purchase price or insufficient portion of the purchase price in the aforementioned step 309, the processing proceeds to step 313, and tentative processing, i.e., registration in a holding stage, is performed at the purchasing organization 12; then, in step 314, a judgment is made regarding the presence or absence of a payment on the following business day.

In cases where such a payment has been made, the processing proceeds to the aforementioned step 310. In cases where there is no payment in step 314, the procedure is canceled in step 315; then, in the next step 316, a registration to the effect that future same-day spot purchasing procedures will not be performed is made in the client data base 26, and the processing is completed.

Furthermore, respective items of information indicating that the sale price of merchandise as described later has been paid as money on deposit and information indicating that the loan fee for the investment service has been paid as money on deposit are registered in the aforementioned client data base 26.

In the abovementioned same-day spot purchasing procedure, the client can apply for same-day spot purchases at any time 24 hours a day from any location using the internet 16.

Furthermore, since the published retail price is indicated with reference to the market price prior to the input of the monetary amount of the same-day spot purchase, the client 18 can make up his mind regarding the purchase on the spot.

Furthermore, in conventional same-day spot purchasing procedures, merchandise is purchased on a weight basis over the counter. In the procedure of the present invention, however, the purchase amount can be automatically calculated at the daily price for precious metals merely by inputting the monetary amount of the purchase form the client server 20, so that the purchase of metals in accordance with the desired monetary amount can be accomplished by a quick and easy procedure; furthermore, since there is no need to re-input this information on the side of the purchasing organization 12, input errors regarding the monetary amount of the purchase can be prevented.

Furthermore, the presence or absence of money on deposit for use in same-day spot purchases can be ascertained in connection with the client data base 26; accordingly, diversification of the settlement method used for charges can be accomplished by inputting data concerning money on deposit as sale funds for the payment of sale charges as described later and data concerning money on deposit as investment service loan fees into this client data base 26.

Furthermore, in the abovementioned same-day spot purchasing procedure, subsequent processing can be automatically accomplished merely by inputting payment information for clients with confirmed payments into the main server 14. In particular, it is possible to input information regarding payments into financial-institution accounts of the purchasing organization 12 on-line by utilizing net banking, so that the manual input of payment information becomes unnecessary, and so that transactions can be concluded at the point in time of on-line input of payment information.

As a result of this, furthermore, the time lag in the confirmation of payments or execution of purchases following applications for same-day spot purchases is eliminated, so that the risk of price fluctuations and the risk of cancellation by clients can be greatly reduced.

Furthermore, in this procedure, the risk on the side of the purchasing organization 12 can be reduced by registering the impossibility of future same-day spot purchases in the client data base in cases where there is ultimately no payment of the purchase price by the client.

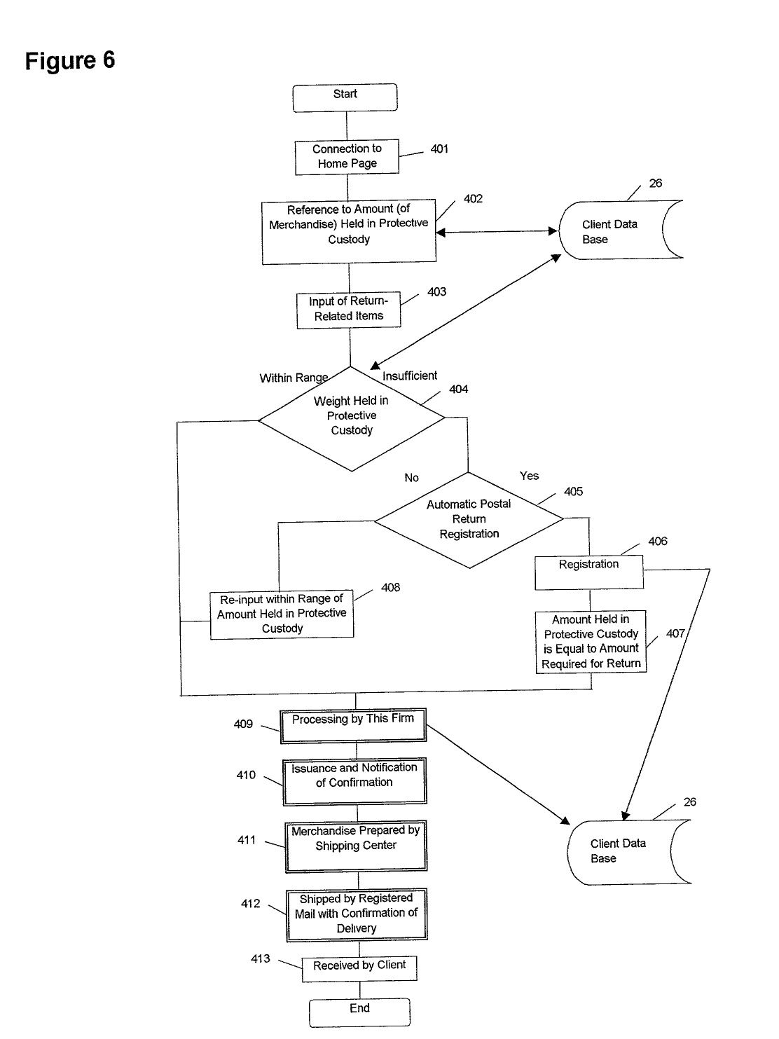

Next, the procedure by which the aforementioned metal merchandise held in protective custody is returned according to the wishes of the client 18 by means of the internet will be described with reference to FIG. 6.

In step 401, the client 18 connects with the aforementioned home page via the internet 16 by means of the client server 20, and calls up the menu screen from the fixed-monetary-amount exclusive use site 36. From this menu screen, the client selects the postal return application/automatic postal return application button 38E. As a result, the amount of merchandise held in protective custody for the aforementioned client is displayed from the client data base 26 via the main server 14 (step 402).

Next, in step 403, the client 18 inputs items related to the return from the client server 20. In the next step 404, the main server 14 refers to the aforementioned client data base 26, and ascertains whether the input weight of the merchandise for which return is desired is within the range of the weight of merchandise held in protective custody, or whether the merchandise held in protective custody is insufficient.

In cases where the abovementioned weight is insufficient, the processing proceeds to step 405, and a judgment is made as to whether or not to execute a return at the point in time at which automatic postal return is registered, i.e., at the point in time at which the insufficiency is made good. In cases where a return is not executed, the processing proceeds to step 406, and the main server 14 sends an invitation to the client server 20 to re-input the weight of the return of the amount of merchandise held in protective custody.

In cases where the desired return weight is within the range of the weight held in protective custody in step 404, or in cases where the desired return weight is re-input within the range of the weight held in protective custody in step 408, the processing proceeds to step 409, and the return procedure is initiated. Furthermore, information regarding this return is registered in the client data base 26.

In the aforementioned step 405, in cases where automatic postal return is to be registered, the processing proceeds to step 409, and this registration is executed. Then, in step 410, in cases where the amount of merchandise held in protective custody is equal to the return weight, the processing proceeds to the aforementioned step 407. Furthermore, information concerning the automatic postal return registration in step 409 is registered in the client data base 26.

When the return procedure is initiated, a confirmation of this procedure is issued in step 410, and the client server 20 of the client 18 is notified of this by means of e-mail, etc. At the same time, furthermore, the shipping center is notified, and a description of the merchandise is prepared by the shipping center in step 411. Then, in step 412, the merchandise for which return is desired is shipped from the shipping center by registered mail with verification of delivery, and in step 413, this merchandise is received by the client, and the procedure is completed.

In conventional return procedures, the procedure is performed in a time-consuming manner by an agent or by sending a postal return application through the mail. However, in the present return procedure utilizing the internet, a return application can be made instantly, and the merchandise can be quickly returned to the client.

Furthermore, in the case of a return application, the form in which the merchandise is to be returned, e.g., in the case of gold, bar type gold or coin type gold, can be confirmed in advance; accordingly, this system is convenient for the user.

Furthermore, in the automatic postal return registration procedure in step 405, the question of whether or not the weight of the merchandise held in protective custody is sufficient has been handled separately in conventional methods; in the procedure of the present invention, however, an automatic judgment is made by the main server 14, and in cases where the amount of merchandise held in protective custody is equal to a certain fixed amount, the return procedure can be initiated immediately. Accordingly, there is no need for separate handling as in conventional methods; furthermore, control costs can be lowered, and client service can be improved.

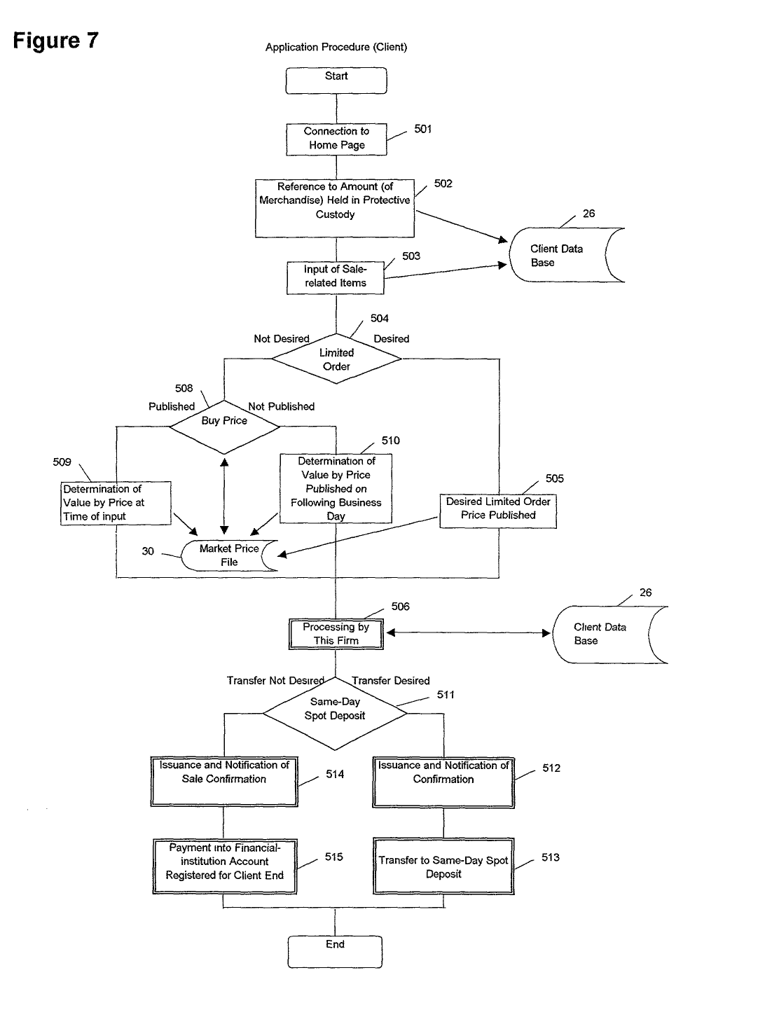

Next, the procedure for the sale of merchandise held in protective custody by means of the internet will be described with reference to FIG. 7.

In the same manner as described above, the client 18 connects to the home page from the client server 20 via the internet 16 (see step 501). Next, the client enters the fixed-monetary-amount exclusive use site 36, and calls up the menu screen shown in FIG. 2. The client then selects the sale price payment application/automatic sale application button 38F.

In step 502, the main server 14 refers to the client data base 26, and indicates the amount [of merchandise] held in protective custody to the client server 20.

In step 503, the client 18 inputs sale-related items from the client server 20. In this case, if there is a limited order of the sale, this is simultaneously input.

In step 504, the main server 14 judges the presence or absence of a limited order; if a limited order is desired, the main server 14 refers to the market price file 30 in step 505. Then, if the desired limited order price has been published, the processing proceeds to step 506, and the sale procedure is executed.

In step 504, in cases where it is judged that there is no desire for a limited order, the processing proceeds to step 508, and it is ascertained whether or not a buy price has been published at this point in time.

In cases where a buy price has been published, the processing proceeds to step 509, and a value is determined at the price at the time of input with reference to the market price file 30; then, the processing proceeds to the aforementioned step 506.

On the other hand, in cases where it is ascertained in step 508 that no buy price has been published, the processing proceeds to step 510, and the value is determined at the published price with reference to the market price file 30 on the following business day. Then, the processing proceeds to the aforementioned step 506.

Information concerning the execution of the sale in step 506 is registered in the client data base 26, and following the execution of the sale, the processing proceeds to step 511, and a judgment is made as to whether or not the client has indicated a desire to transfer the money on deposit generated by the sale to same-day spot money on deposit. If there is a desire for such a transfer, the processing proceeds to step 512, and in this step, a transfer confirmation is issued, and the client 18 is notified of this by e-mail. Then, in step 513, funds corresponding to the sale price are transferred to money on deposit.

In cases where there is no desire for such a same-day spot deposit transfer, the processing proceeds to step 514; in this step, a sale confirmation is issued, and the client 18 is notified of this by e-mail. Then, the processing proceeds to step 515, funds corresponding to the sale price are paid into the financial-institution account registered for the client, and the procedure is completed.

In this series of sale price payment procedures utilizing the internet, the desire of the client to sell at the market price can be determined at the time that the client makes the application for sale; accordingly, the price fluctuation risk to the client can be reduced.

In conventional methods, on the other hand, the client requests a sale application form from the purchasing organization, returns this sale application form to the purchasing organization, and sells the merchandise at the price [that prevails] at the time that the application form arrives at the purchasing organization; accordingly, there is a risk of price fluctuation during this period.

Furthermore, in this sale price payment procedure utilizing the internet, three different prices, i.e., the limited order, the buy price published at the time of the sale, or the published price on the following business day, can be selected as the market price applied to the sale price. Furthermore, by using the limited order, the client has an opportunity to sell at his desired price without taking the trouble to confirm the market price. Furthermore, a case in which the client desires the abovementioned limited order and there is no publication of this designated desired price was not described in the abovementioned working configuration; in such a case, however, the system may be arranged so that an effective period for the limited order is set, and in cases where the desired price is not published during this period, the client is notified by e-mail, and the registration of the limited order is automatically canceled.

As a result, the client can alter the limited order in accordance with market price conditions, and can reassess the designate value by receiving an e-mail indicating cancellation.

In conventional methods, furthermore, the payment of funds to the client is handled by cash or bank payments made over the counter; in the present working configuration, however, funds realized by sales can be held as money on deposit. Accordingly, such funds realized by sales can be drawn on as funds for the next purchase. As a result, the settlement of same-day spot purchase charges on the client's side can be simplified, and payment handling fees can be reduced.

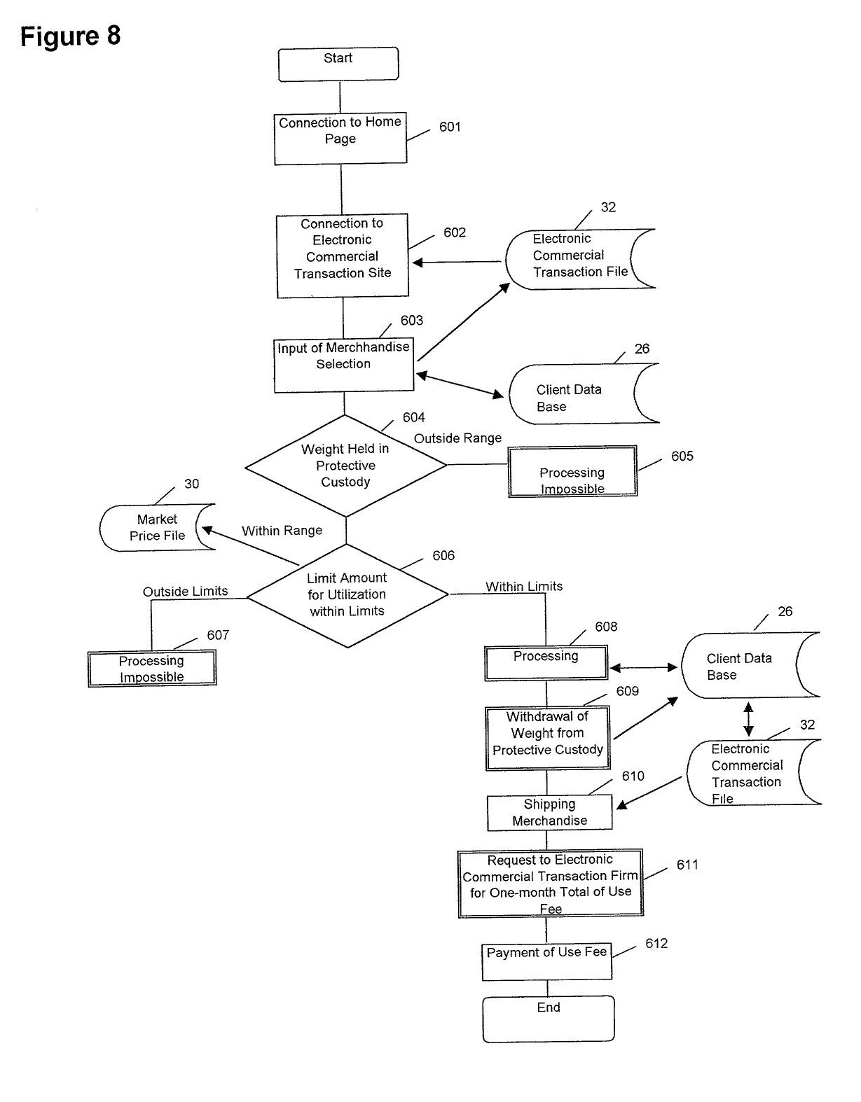

Next, the procedure by which merchandise held in protective custody is exchanged for other merchandise of equal value utilizing the internet will be described with reference to FIG. 8.

The client 18 connects to the aforementioned home page from the client server 20 via the internet 16 (see step 601). Next, in step 602, the client makes a connection from the fixed-monetary-amount exclusive use site 36 shown in FIG. 2 to an electronic commercial transaction site 40 which is linked with the fixed-monetary-amount exclusive use site 36.

From this electronic commercial transaction site 40, reference is made to the aforementioned electronic commercial transaction file 32, and information concerning the merchandise that is the object of the electronic commercial transaction is sought. Then, in step 603, the desired merchandise is selected. At the same time, a merchandise selection input signal for this merchandise is registered in the aforementioned electronic commercial transaction file 32 and in the client data base 26.

When merchandise selection information is input by the client, the main server 14 makes a judgment in step 604 as to whether or not the price of the selected merchandise exceeds the range of the weight price of merchandise held in protective custody.

In cases where the abovementioned range is exceeded, the processing proceeds to step 605, and further processing becomes impossible. If the price of the selected merchandise is within the abovementioned range, the processing proceeds to step 606, where reference is made to the market price file 30, and a judgment is made as to whether or not the price of the weight of precious metals held in protective custody is within the limits of the equal-value exchange price of the selected merchandise, i.e., as to whether this price is within the limits of utilization, or exceeds these limits (step 606).

If the abovementioned limits are exceeded, the processing proceeds to step 607, and further processing becomes impossible. If the price is within the abovementioned limits, the processing proceeds to step 608, and processing for an equal-value exchange is executed. This equal-value exchange processing is executed with reference being made to the client data base 26.

Next, the processing proceeds to step 609, and a weight of merchandise corresponding to the merchandise held in protective custody for which an equal-value exchange was executed is withdrawn; furthermore, this is registered in the client data base 26.

Data concerning the results of this withdrawal of merchandise held in protective custody is sent to the electronic commercial transaction file 32, and instructions for the shipping of the merchandise are issued from here in step 610.

In step 611, following the shipping of the merchandise, the total monetary amount of the use fee for a fixed period, e.g., one month, is requested from the electronic commercial transaction firm, and in step 612, the use fee is paid into the financial-institution account of the purchasing organization 12 by the electronic commercial transaction firm, and the procedure is completed.

In this equal-value exchange system utilizing the internet, merchandise held in protective custody is evaluated at the market price on the day in question, and is exchanged for the merchandise that is the object of the electronic commercial transaction, so that quick settlement is possible. Conventional means used for the settlement of electronic commercial transactions consist mainly of credit cards, bank transfer, and cash on delivery, so that time and effort are required for settlement.

Furthermore, since merchandise can be selected by referring to the electronic commercial transaction file after connecting to the electronic commercial transaction site, the quantities of various types of merchandise that are in stock is clear to the client, so that the time that it takes for the merchandise to be received is also clear.

Furthermore, in the case of conventional electronic commercial transactions, the payment of funds is not guaranteed, so that there is a risk of non-recovery. Moreover, in cases where credit cards are used, there is a risk of misuse of credit card numbers, etc. However, in the case of this equal-value exchange system utilizing the internet, instructions for the shipping of merchandise are issued after data indicating the results of withdrawal of metal held in protective custody is sent to the electronic commercial transaction file; accordingly, there are no problems of non-recovery of funds or misuse of credit card numbers, etc.

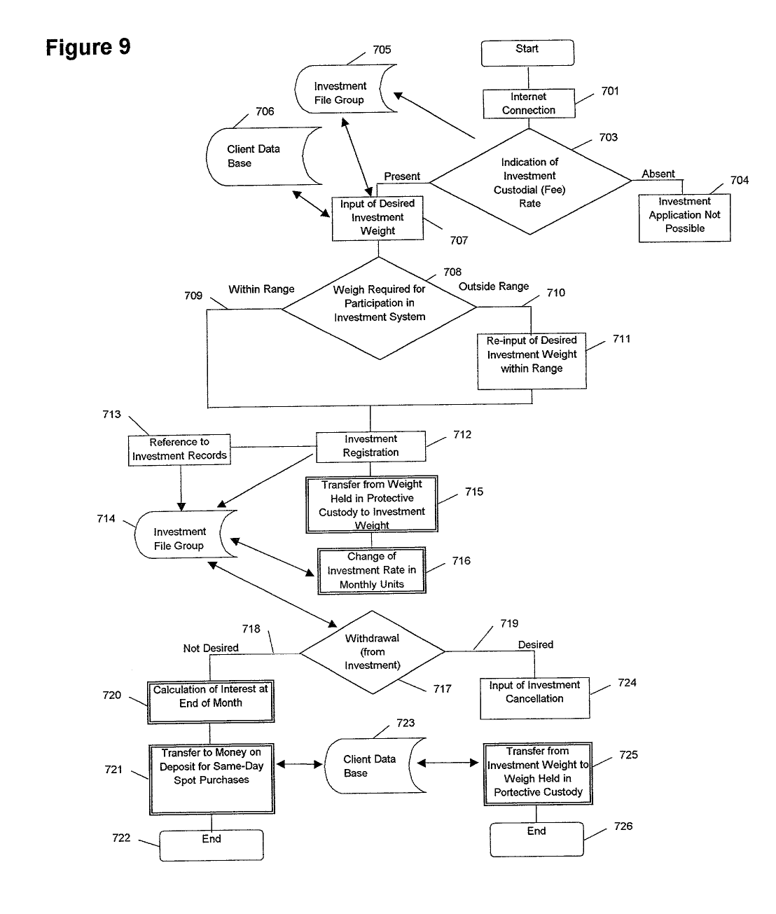

Next, the system used to employ merchandise held in protective custody in an investment service utilizing the internet will be described with reference to FIG. 9.

First, in step 701, the client connects to the home page in the same manner as described above; the client then calls up the menu screen from the fixed-monetary-amount exclusive use site 36 shown in FIG. 2, and selects the investment service button 38H.

When this investment service button 38H is selected, the main server 14 refers to the investment file 34, indicates the investment custodial fee rate, and invites the client 18 to select “yes” or “no”.

Next, in step 703, a judgment is made as to whether or not the investment custodial fee rate has been approved; if there is no approval, the processing proceeds to step 704, and the investment application is invalidated.

If the investment custodial fee rate is approved, the processing proceeds to step 707, and the main server 14 invites the input of the desired investment weight from the client server 20 of the client 18. If such input is made, a judgment is made in step 708 with reference to the aforementioned investment file 34 and client data base 26 as to whether or not the aforementioned desired investment weight is within the range of the weight required for participation in the investment system. Here, the “weight required for participation in the investment system” refers to the weight that is feasible for investment by the purchasing organization in accordance with market conditions.

In cases where the results of the abovementioned judgment are outside the range of the weight required for participation in the investment system, the processing proceeds to step 710, and information inviting the re-input of a desired investment weight that is within the abovementioned range is output to the client 18 via the client server 20.

In cases where a desired investment weight that is within the abovementioned range is re-input, or in cases where the judgment results obtained in the aforementioned step 708 are within the abovementioned range, the processing proceeds to step 712, and the investment is registered and initiated.

At the same time, in step 715, a transfer is made from the weight held in protective custody to the aforementioned input investment weight. In step 714, the results of the investment are successively registered in the investment file 34.

When the investment is executed, the investment rate changes in monthly units as shown in step 716. In this case, reference is made to the aforementioned investment file, and the investment is optimally adjusted in accordance with market conditions. When the investment rate changes in monthly units, the main server 14 outputs information to the client server 20 inviting a decision regarding the question of whether or not to withdraw the merchandise constituting the investment weight, i.e., the question of whether or not to cancel the investment. If there is input form the client 18 indicating whether or not the client desires to withdraw the merchandise, a judgment regarding the presence or absence of such a desire to withdraw the merchandise is made in step 717.

In cases where the client desires to withdraw the merchandise, the processing proceeds to step 724, and an investment cancellation is input. Then, in step 725, a transfer is made from the investment weight to the weight held in protective custody, and merchandise of the aforementioned weight that had been invested is returned to protective custody; at the same time, information indicating this is registered in the client data base 26, and processing is completed.

In cases where the judgment results obtained in step 717 indicate that there is no desire to withdraw the merchandise, the processing proceeds to step 720, and the interest on the invested metals is calculated at fixed intervals, e.g., at the end of each month. Then, in step 721, a transfer is made to the money on deposit for same-day spot purchases; furthermore, data indicating this is registered in the client data base 26, and the procedure is completed.

In this investment service system utilizing the interne, the range of the weight required for participation in the investment system is set; accordingly, it is possible at all times to collect only weights that are feasible for investment in accordance with prevailing market conditions. As a result, investment costs can be lowered compared to cases where there is an agreement to invest the entire amount of merchandise held in protective custody at one time.

In this case, furthermore, the client also enjoys the following advantages: specifically, the client can quickly select an investment accompanied by risk, or specified storage protective custody that involves no risk. Moreover, the extent of the risk that is assumed can be limited by investing only a portion of the amount of merchandise held in protective custody. Furthermore, since the investment rate is indicated in step 703, the client can more easily decide whether or not to make an application for investment.

Furthermore, since the investment results are successively registered in the investment file 34 in step 713, the client can easily ascertain the results of the investment. Moreover, on the side of the purchasing organization 12 as well, there is no need for a separate notification of each investment, so that the procedure can be simplified, and the amount of money spent on postage can be reduced.

Furthermore, since the investment rate can be altered at fixed intervals, e.g., in monthly units, in accordance with market conditions, the payment of fair interest is possible, and the risk to the purchasing organization can be reduced.

Moreover, since the client can cancel the investment at any time whenever the investment rate is altered in monthly units, the investment can be canceled in cases where there is, for example, a rise in the market price, etc., and the merchandise can immediately be sold, so that there is no delay in the timing of sale of the merchandise.

Furthermore, the payment of monthly interest charges to the client is accomplished by the transfer of funds to money on deposit in the client's account; accordingly, bank payment fees are unnecessary, so that costs can be reduced, and the client can quickly invest the money on deposit by using these funds for same-day spot purchases, etc.

As was described above, the present system is arranged so that the aforementioned clients 18 connect to the main server 14 of the purchasing organization 12 from the client servers 20 via the internet 16. However, the present invention is not limited to such an arrangement; it would also be possible to use so-called portable terminals utilizing i mode, etc., instead of client servers.

Furthermore, in either case, it goes without saying that security is guaranteed by utilizing encryption techniques to encrypt data whenever such data is transmitted.

Furthermore, in cases where merchandise held in protective custody is displayed to clients from the client data base 26, such a display is more easily comprehended if images of the merchandise such as photographs or computer graphics, e.g., images of 30 gold bars or 15 gold coins, etc., are displayed in accordance with the amount of the merchandise. This creates a feeling of reality, and is a service to the clients.

With the structures and functions as described in the above, the present invention possesses advantages over the prior art systems in providing customers with a more efficient and safe investment system on fixed-monetary-amount purchase for precious metals such as gold and platinum without lagging behind market prices.

It should be apparent to those skilled in the art that the above-described embodiments are merely illustrative of a few of the embodiments of the present invention which could be modified by one of ordinary skills in the art without departing from the spirit and scope of the present invention.

We claim:

1: A fixed-monetary-amount purchasing system for precious metals comprising the steps of:
(a) registering for each of client accounts in a client data base, (i) information concerning clients who have concluded fixed-monetary-amount purchasing agreements with a purchasing organization for the continued purchase of merchandise comprising precious metals at a fixed purchase price at fixed intervals, (ii) information concerning said merchandise that has been purchased by said clients and that has been placed in protective custody in a client account established with said purchasing organization, (iii) information concerning money deposited by clients in said client accounts, (iv) information concerning accounts at financial institutions used for settlement by said clients, and (v) information concerning said fixed prices of said fixed-monetary-amount purchases that have been requested by said clients,
(b) recording in said client data base via a main server of said purchasing organization at the time of fixed-monetary-amount purchases, (i) the presence or absence of a payment into the financial-institution account of said purchasing organization, and (ii) means of payment, either a transfer of funds corresponding to said purchase price from said financial-institution accounts of said clients or a cash payment
(c) purchasing merchandise on each business day with an amount of money determined by dividing said purchase price by the number of business days within a fixed period when recording of said payment in said client data base is confirmed,
(d) storing said purchased merchandise in protective custody for said client accounts in each instance, and
(e) settling at a request of said clients for said merchandise stored in said protective custody by providing actual merchandise, exchanging said merchandise for other merchandise of equal value, or paying funds resulting from sale of said merchandise.

2: A fixed-monetary-amount purchasing system for precious metals according to claim 1, wherein (a) a main server provisionally registers client information obtained from said request in said client data base, when a potential client desiring a fixed-monetary-amount purchasing agreement sends a request for such an agreement to a main server of said purchasing organization via a communications circuit, and (b) said provisional registration in said client data base is updated to a full registration, said client account is set in said client data base, and said client is informed of acceptance of said full registration, when a financial-institution account used for settlement by said client has been established.

3: A fixed-monetary-amount purchasing system for precious metals according to claim 1, wherein, said main server determines purchase weight from said purchase price by referring to a market price file, and confirms either that said purchase price has been paid from said financial-institution account of said client, or that said purchase price remains in said client account at said purchasing organization as a deposit, and following said confirmation, purchase of merchandise of said purchase weight is executed, and purchased merchandise is stored in protective custody in said client account, when a client sends a request for a spot purchase of merchandise including purchase price data to said main server by means of a client server via a communications circuit

4: A fixed-monetary-amount purchasing system for precious metals according to claim 1, wherein said confirmation of payments into the financial-institution account of the aforementioned purchasing organization is accomplished by said main server using net banking.

5: A fixed-monetary-amount purchasing system for precious metals according to claim 3, a purchase confirmation notification is sent to said client data base and client server via a communications circuit following execution of said purchase of said merchandise.

6: A fixed-monetary-amount purchasing system for precious metals according to claim 3, wherein said main server refers to the aforementioned client data base and supplies information concerning the merchandise held in protective custody to said client server, invites an application from said client server to said main server for return of merchandise within the limits of said merchandise stored in said protective custody, and said main server transmits a confirmation of said return to said client server, rewrites said information concerning said merchandise stored in said protective custody in said client data base, and arranges execution of said return of said merchandise, when a client who desires return of merchandise in said protective custody sends a request for a balance inquiry regarding merchandise stored in said protective custody to said main server from his client server via a communications circuit,

7: A fixed-monetary-amount purchasing system for precious metals according to claim 6, said main server refers to said client data base and judges whether or not a balance of said merchandise stored in said protective custody following said return exceeds the minimum amount stored in said protective custody, and if results of said judgment are positive, said main server executes a return procedure, when there has been a request for a return of merchandise.

8: A fixed-monetary-amount purchasing system for precious metals according to claim 7; wherein said main server selects an option of (a) transmitting information to said client server that invites a re-application for return within limits that leaves said minimum amount stored in said protective custody, or (b) performing an automatic return registration, and executing said return procedure when said amount stored in said protective custody reaches said minimum amount stored in said protective custody for which said return is requested, when said judgment results obtained by said main server are negative for said request for said return of merchandise.

9: A fixed-monetary-amount purchasing system for precious metals according to claim 3, wherein said main server refers to said client data base and supplies information concerning said merchandise stored in said protective custody to said client server, said main server also invites an application from said client server to said main server for sale of merchandise within the limits of said merchandise stored in said protective custody, and after executing said sale, said main server transmits confirmation of said sale to the client server, rewrites the information concerning said merchandise stored in said protective custody in said client data base, and either deposits a revenue from said sale in said client account or pays said revenue to said financial-institution account of said client, when a client who desires to sell merchandise stored in said protective custody sends a request for a balance inquiry regarding merchandise stored in said protective custody to said main server from his client server via a communications circuit,

10: A fixed-monetary-amount purchasing system for precious metals according to claim 9, wherein upon receiving a request for sale of merchandise from a client, said main server supplies a signal inviting designation of a desired sale price to said client server, said main server refers to a market price file which has current market price data for merchandise within a fixed period of time in cases there is a designation of a desired sale price by said client, and executes a purchase from said client at said designated price if said designated price appears in said market price file, and said main server notifies said client of said sale, and cancels acceptance of said sale request in cases where said designated price does not appear in the market price file.

11: A fixed-monetary-amount purchasing system for precious metals according to claim 3, wherein said main server can be connected via an electronic commercial transaction site to an electronic commercial transaction file in which various types of information concerning electronic commercial transactions are registered, said main server sends a signal inviting selection of desired merchandise from said electronic commercial transaction file, and an application for equal-value exchange, to said client server, and said main server refers to said client data base when said client selects merchandise and applies for an equal-value exchange, and if the value of said merchandise stored in said protective custody exceeds said value of said selected merchandise, said main server subtracts an amount of merchandise stored in said protective custody that is equal in value to said selected merchandise, rewrites said client data base, and sends instructions to said electronic commercial transaction file for said purchase of said selected merchandise and shipping of said merchandise to said client. when a client who desires an equal-value exchange of merchandise stored in said protective custody is connected to said electronic commercial transaction file of said main server from said client server via a communications circuit.

12: A fixed-monetary-amount purchasing system for precious metals according to claim 3, said main server judges whether or not the weight of the aforementioned merchandise is within the standard weight range for investment, and if the results of this judgment are positive, said main server transfers merchandise of the aforementioned weight from protective custody and executes the investment.

13: A fixed-monetary-amount purchasing system for precious metals according to claim 12, wherein data concerning performance of said investment is accumulated in an investment file to which said client server of said client for whom said investment is registered can be connected, and said client can refer to said investment file at any time, when a signal inviting an application for investment of merchandise stored in said protective custody has been sent along with investment rate information to said client server of said client by said main server, and there has been an application for investment from said client specifying a weight of merchandise to be invested that is within the weight range of said merchandise stored in said protective custody

14: A fixed-monetary-amount purchasing system for precious metals according to claim 13, wherein marketplace information including a market price of said merchandise that is the object of investment is successively accumulated in said investment file, said investment rate is periodically updated with reference to said marketplace information, said updated investment rate is submitted to said client via said investment file, and in cases where said client is invited to submit an application indicating whether or not said investment at said updated investment rate is to be canceled, and if there is an application from said client to cancel said investment, said registration of said investment is canceled and said merchandise is transferred to be stored in said protective custody for said client.

15: A fixed-monetary-amount purchasing system for precious metals according to claim 14, wherein a loan charge for said invested merchandise is saved as a fund for spot purchases for said client, if there is no application for cancellation of said investment.

16: A fixed-monetary-amount purchasing system for precious metals according to any of claims 1 through 15, wherein said main server sends at least one type of menu information concerning (a) a balance inquiry requests for merchandise stored in said protective custody for said clients, (b) transaction history inquiry requests, (c) spot purchase applications, (d) applications for duplicate subscriptions, (e) introduction of new clients, (f) applications for a return of merchandise stored in said protective custody, (g) applications for an equal-value exchange of merchandise stored in said protective custody for other merchandise, or (h) applications for an investment service for merchandise stored in said protective custody, to said clients via a communications circuit, invites the clients to select desired information, and receives a selection made by said clients.

17: A fixed-monetary-amount purchasing system for precious metals according to claim 16, an image of merchandise stored in said protective custody is displayed by said client server in accordance with types and weight of said merchandise, when a balance inquiry request if selected from said menu information.
